(19) United States
(12) Patent Application Publication
(10) Pub. No.: US 2011/0164691 A1
(43) Pub. Date: Jul. 7, 2011

(54) CLOSED-LOOP TRANSMISSION FEEDBACK IN WIRELESS COMMUNICATION SYSTEMS

(75) Inventors: Timothy A. Thomas, Palatine, IL (US); Bishwarup Mondal, Oak Park, IL (US)

(73) Assignee: MOTOROLA, INC., Schaumburg, IL (US)

(21) Appl. No.: 12/874,552

(22) Filed: Sep. 2, 2010

Related U.S. Application Data
(60) Provisional application No. 61/292,644, filed on Jan. 6, 2010.

(51) Int. Cl. H04L 27/00

(52) U.S. Cl. 375/259

(57) ABSTRACT

A method and apparatus for providing channel feedback is provided herein. During operation a covariance matrix at time t (R) is calculated by the mobile as a function of a received downlink signal. In order to reduce overhead, R is normalized and quantized by the mobile using multiple codebook entries plus at least one constant for quantization. The mobile then transmits the normalized and quantized covariance matrix back to the base station as bit values indicating the selected entries from the codebook plus bit values corresponding to the at least one constant. The base unit then uses the covariance matrix estimate to determine appropriate channel beamforming weights, and instructs transmit beamforming circuitry to use the appropriate weights.

### FIELD OF THE DISCLOSURE

The present disclosure relates generally to wireless communications and more particularly to closed-loop transmission feedback in wireless communication systems and methods.

### BACKGROUND

In wireless communication systems, transmission techniques involving multiple antennas are often categorized as open-loop or closed-loop, depending on the level or degree of channel response information used by the transmission algorithm. Open-loop techniques do not rely on the information of the spatial channel response between the transmitting device and the receiving device. They typically involve either no feedback or the feedback of the long term statistical information that a base unit may use to choose between different open loop techniques. Open-loop techniques include transmit diversity, delay diversity, and space-time coding techniques such as the Alamouti space-time block code.

Closed-loop transmission techniques utilize knowledge of the channel response to weight the information transmitted from multiple antennas. To enable a closed-loop transmit array to operate adaptively, the array must apply the transmit weights derived from the channel response, its statistics or characteristics, or a combination thereof. There are several methodologies for enabling closed-loop transmission. These are discussed in the context of the downlink of a cellular communication system in which a base station (BS) (sometimes referred to as a base unit or access point or node-B or eNode-B) with multiple antennas transmits to a mobile station (MS) (sometimes referred to as a mobile or remote unit or user equipment or UE) having one or more receive antennas and one or more transmit antennas. The MS may not necessarily have the same number of transmit antennas as receive antennas. Exemplary closed-loop methodologies include adaptive transmit beam-forming, closed-loop single-user MIMO, closed-loop multi-user MIMO, and coordinated multi-point transmission (or CoMP). In these examples, the transmitter applies weighting coefficients that are derived according to an optimization algorithm to control characteristics of the transmitted signal energy.

One methodology for enabling closed-loop transmission is codebook index feedback in which both the BS and MS maintain one or more finite codebooks of possible transmit weight vectors or matrices, depending on the number of simultaneous transmit beams being formed. The MS measures the downlink multi-antenna channel response and computes the transmit weight vector or matrix that is best suited to transmit information to itself. Specifically a MS chooses the best transmit weight vector or matrix to optimize the data reception performance when the same transmit weight vector or matrix is used by the BS to transmit data to the MS. An MS may also choose multiple elements (vectors or matrices) from one or more codebooks and combine them to construct a single transmit weight vector or matrix. While choosing multiple elements the goal is to optimize the data reception performance when the transmit weight vector or matrix as constructed from the combination is used by the BS to transmit data to the MS. The MS then transmits the index into the codebook back to the BS, where the index into the codebook is often called a Precoding Matrix Index (PMI). The BS uses the transmit weight vector or matrix corresponding to the index fed back by the MS. The particular codebook that a MS and a BS uses may change from time to time. The BS has the flexibility to change the transmit weight vector or matrix recommended by the MS for transmission. Codebook index feedback can be applied to both frequency division duplex (FDD) and time division duplex (TDD) systems.

Another methodology for enabling closed-loop transmission is direct channel feedback (DCFB), wherein the MS measures the downlink channel response and encodes that channel response as an analog signal to be conveyed on the uplink. The downlink channel response estimates are encoded along with known pilot signals that enable the BS to estimate the analog values of the downlink channel estimates. DCFB can be applied to both FDD and TDD systems.

Another methodology for enabling closed-loop transmission is analog covariance matrix or analog eigenvector feedback. In covariance feedback the MS measures the downlink channel response, computes a covariance matrix for the band of interest, and then feeds back the values of the covariance matrix in an analog fashion to the BS. For eigenvector feedback, the MS obtains a covariance matrix similar to that of covariance feedback but then computes the dominant eigenvector or eigenvectors of the covariance matrix and feeds back the eigenvector or eigenvectors in an analog fashion to the BS.

Another methodology for enabling closed-loop transmission is quantized eigenvector feedback. In this method the eigenvectors of the channel covariance matrix are quantized (using vector quantization) to one or more vectors or matrices and are sent back to the BS. The objective for the quantization method is to accurately represent the dominant eigenvectors of the covariance matrix.

Yet another methodology for enabling closed-loop transmission is to quantize the elements of the covariance matrix by a fixed number of bits with fixed and predefined amplitude and phase range. Specifically the quantization function that maps an unquantized value or a set of values to a quantized value or a set of values is predefined and fixed for a given size of the covariance matrix. In addition the quantization of one element of the covariance matrix or a set of elements of the covariance matrix does not depend on the quantization of the elements outside the set. Then the MS feeds back the fixed number of bits and the BS is able to get a one-time estimate of the covariance matrix which tends to have fairly high quantization error.

While the above-techniques provide a method for channel feedback, the codebook-based techniques do not provide the rich channel information provided by the covariance feedback and the covariance feedback does not use the simple and elegant feedback of the codebook-based methods. Hence a method is needed to obtain the channel quality of covariance-based feedback with the simple and elegant feedback of the codebook-based methods.

### BRIEF DESCRIPTION OF THE DRAWINGS

FIG. 1 is a wireless communication system.

FIG. 2 is a block diagram of a closed-loop transmit antenna array communicating a single data stream to a receiving device.

FIG. 3 is a block diagram of a closed-loop transmit antenna array communicating multiple data streams to a receiving device.

FIG. 4 is a block diagram of a frequency domain-oriented broadband transmission system employing a closed-loop transmit antenna array.

FIG. 5 is a block diagram of a remote unit using the method.

FIG. 6 is a block diagram for a base unit requesting a CBCM feedback subchannel and receiving CBCM feedback from a remote unit.

FIG. 7 is a flow chart showing operation of the CBCM feedback process at a remote unit.

FIG. 8 is a flow chart showing operation of requesting and receiving CBCM feedback at a base unit.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

In order to address the above-mentioned issues, a method and apparatus for providing channel feedback is provided herein. During operation a covariance matrix at time t (R) is calculated by the mobile as a function of a received downlink signal. In order to reduce overhead, R is normalized and quantized by the mobile using multiple codebook entries plus at least one constant for quantization. The mobile then transmits the normalized and quantized covariance matrix back to the base station as bit values indicating the selected entries from the codebook plus bit values corresponding to the at least one constant. The base unit then uses the normalized and quantized covariance matrix estimate to determine appropriate channel beamforming weights, and instructs transmit beamforming circuitry to use the appropriate weights.

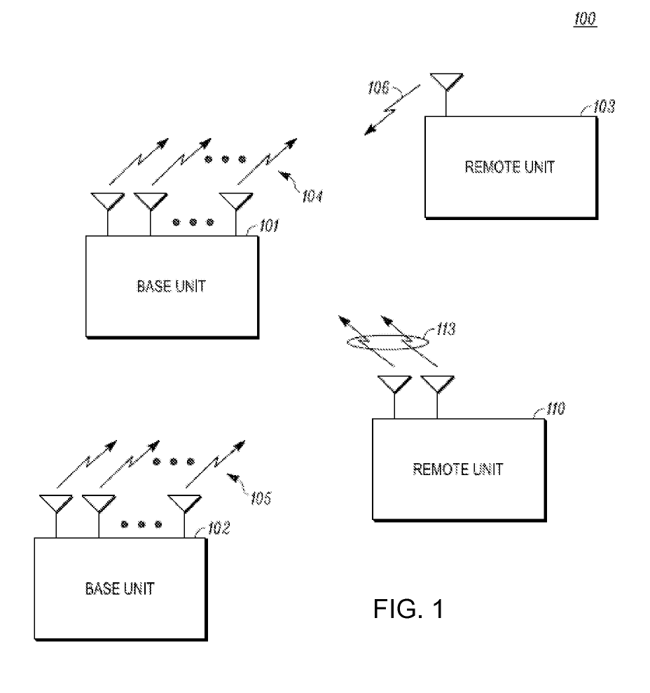

In FIG. 1, the wireless communication system 100 includes one or more fixed base infrastructure units forming a network distributed over a geographical region. The base unit may also be referred to as an access point, access terminal, BS, Node-B, eNode-B, or by other terminology used in the art. In FIG. 1, the one or more base units 101 and 102 serve a number of remote units 103 and 110 within a serving area, for example, a cell, or within a cell sector. In some systems, one or more base units are communicably coupled to a controller forming an access network that is communicably coupled to one or more core networks. The disclosure however is not intended to be limited to any particular wireless communication system.

Generally, the serving base units 101 and 102 transmit downlink communication signals 104 and 105 to remote units in the time and/or frequency domain. Remote units 103 and 110 communicate with one or more base units 101 and 102 via uplink communication signals 106 and 113. The one or more base units may comprise one or more transmitters and one or more receivers that serve the remote units. The remote units may be fixed or mobile user terminals. The remote units may also be referred to as subscriber units, mobile stations (MSs), users, terminals, subscriber stations, user equipment (UE), user terminals, or by other terminology used in the art. The remote units may also comprise one or more transmitters and one or more receivers. The remote units may have half duplex (HD) or full duplex (FD) transceivers. Half-duplex transceivers do not transmit and receive simultaneously whereas full duplex terminals do.

In the preferred embodiment, the communication system utilizes orthogonal frequency division multiple access (OFDMA) or a multi-carrier based architecture on the downlink and for uplink transmissions. Exemplary OFDMA based protocols include the Long Term Evolution (LTE) of the 3GPP UMTS standard and IEEE 802.16 standard. Although the preferred embodiment utilized OFDMA, other modulation methods may also be employed such as interleaved frequency-division multiple access (IFDMA), DFT spread OFDM, multi-carrier code-division multiple access (MC-CDMA), multi-carrier direct sequence CDMA (MC-DS-CDMA), Orthogonal Frequency and Code Division Multiplexing (OFCDM), or cyclic-prefix single carrier.

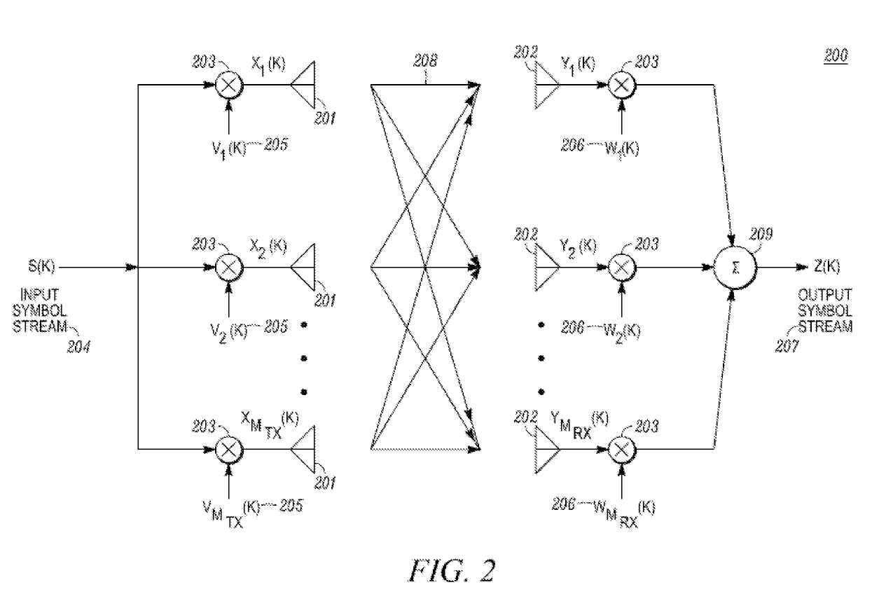

FIG. 2 is a block diagram of a closed-loop transmit antenna array as part of a base unit communicating a single data stream to a receiving device as part of a remote unit having one or more receive antennas. Input stream 204 is multiplied by transmit weights 205 using multipliers 203 before being fed to the multiple transmit antennas 201. Multiplying input stream 204 by transmit weights 205, where the transmit weights are based on at least a partial channel response, is an example of tailoring a spatial characteristic of the transmission. The transmit weights can be calculated from fed-back information such as the covariance matrix or eigenvectors using a method known in the art. The signals transmitted from the multiple transmit antennas 201 propagate through a matrix channel 208 and are received by multiple receive antennas 202. The signals received on the multiple receive antennas 202 are multiplied by receive weights 206 using multipliers 203 and summed by a summation device 209 to produce an output symbol stream 207. In embodiments where the transmitter has only a single antenna, the spatial characteristic of the transmit signal cannot be tailored. However, other characteristics of the transmit signal may be tailored based on at least a partial channel response, such as the complex gain of each sub-carrier (e.g., in a pre-equalization application), or the modulation and coding used on the sub-carriers of the transmit signal.

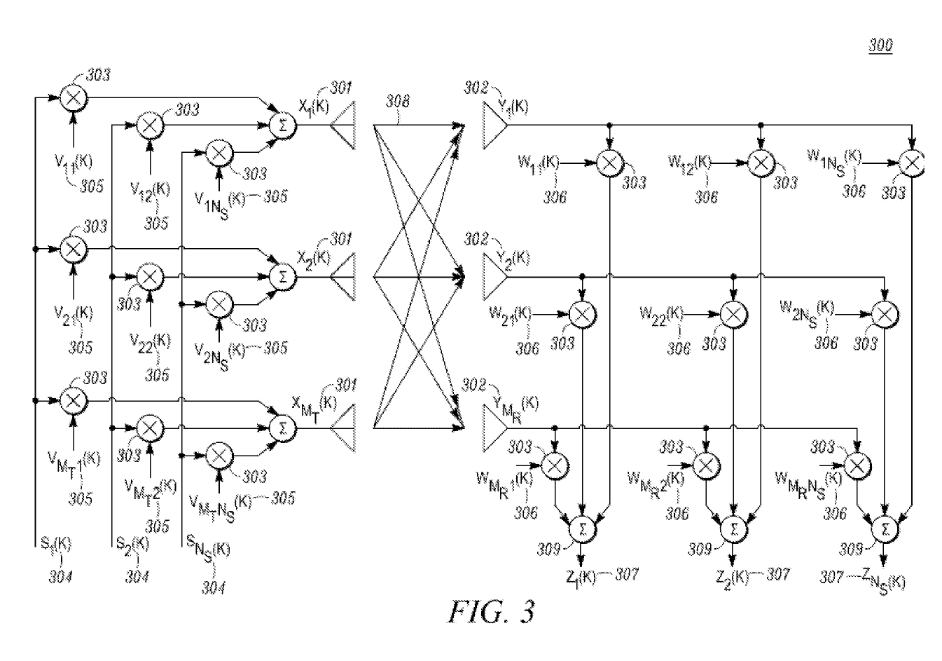

FIG. 3 is a block diagram of a closed-loop transmit antenna array as part of a base unit communicating multiple data streams to a remote unit having one or more receive antennas, for example, a MIMO system. Multiple input streams 304 are multiplied by transmit weights 305 using multipliers 303 before being fed to the multiple transmit antennas 301. The signals transmitted from the multiple transmit antennas 301 propagate through a matrix channel 308 and are received by multiple receive antennas 302. The signals received on the multiple receive antennas 302 are multiplied by receive weights 306 using multipliers 303 and summed by summation devices 309 to produce the multiple output symbol streams 307. Multiplying input streams 304 by transmit weights 305 where the transmit weights are based on at least a partial channel response is another example of tailoring a spatial characteristic of the transmission. Other schemes for producing the output symbol streams 307 are possible, such as maximum likelihood detection or successive cancellation that may or may not use the receive weights 306 and the multipliers 303.

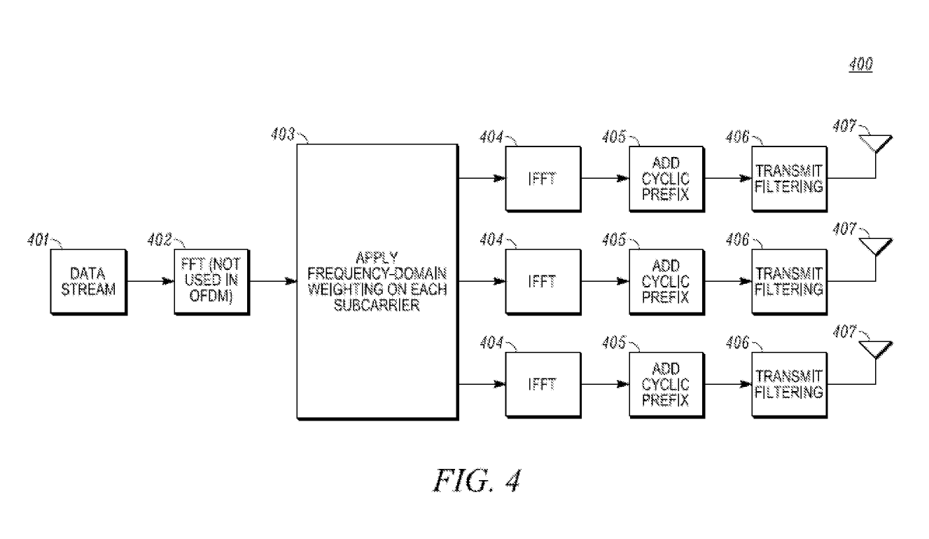

FIG. 4 is a block diagram of a frequency-domain oriented transmission system such as OFDM or cyclic prefix single carrier (CP-Single Carrier) in which the transmission techniques of FIG. 2 and FIG. 3 are performed in the frequency domain prior to transmission. In a CP-Single Carrier system, one or more data streams 401 are first brought into the frequency domain with one or more fast Fourier transforms (FFTs) 402 and the frequency domain data streams are weighted with frequency domain weighting apparatus 403. In OFDM, the one or more data streams 401 are sent directly to frequency domain weighting apparatus 403 without the use of FFT 402. The frequency domain weighting apparatus 403 implements the weighting function shown in the transmit portion of FIG. 2 and FIG. 3 on each sub-carrier or frequency bin in the frequency domain. Thus, the transmit signal can be tailored either spatially, or in frequency, or both with this type of a system. The outputs of the frequency domain weighting apparatus 403 are then brought back into the time domain with IFFTs 404. Cyclic prefixes are added 405 as is known in the art. Transmit filtering 406 is then performed before sending the transmitted signals to the transmit antennas 407.

A more detailed explanation of the codebook-based covariance matrix (CBCM) feedback method is now provided. A spatial covariance matrix or more generally ‘spatial transmit covariance matrix’ captures the correlations between various transmit antennas as experienced in a certain propagation environment. It also captures the received power at the terminal corresponding to each transmit antenna. An instantaneous covariance matrix can be defined for each data subcarrier i, based on the downlink channel estimates available at a time instant (hence can also be referred to as short-term covariance matrix)

Rᵢ=Hᵢ^{H}Hᵢ

where Hᵢ is the N_{R}×N_{T} channel matrix estimated by the terminal on the downlink where N_{R} is the number of receive antennas at the remote unit and N_{T} is the number of transmit antennas at the BS. A remote unit can accumulate or average the per-subcarrier instantaneous or short-term covariance matrix over multiple subcarriers. A narrow band covariance matrix is accumulated over subcarriers that encompass a small portion of the operational bandwidth (sometimes referred to as “sub-band”). A wideband or broadband covariance matrix is accumulated over the entire band or a large portion of the band. A remote unit can also accumulate an instantaneous covariance matrix over time to obtain a long-term statistical spatial covariance matrix. In another form, a remote unit may compute the above estimate by including only the rows in the channel matrix corresponding to a subset of the receive antennas on which measurements are available. Also note that a remote unit may obtain the covariance matrix without having to estimate the channel explicitly, for example, by correlating the received pilots sent from each transmit antenna. In an alternate embodiment, the spatial covariance matrix may be replaced by an (any) Hermitian matrix. The coefficients of the Hermitian matrix may be analog (meaning not quantized and coded or modulated with a digital modulation technique e.g. QPSK, QAM) and may or may not be a direct function of the spatial covariance matrix. Examples of such matrices include σ²I, R+σ²I where I is an N_{T}×N_{T} identity matrix, σ² is a real scalar and R is an N_{T}×N_{T} spatial covariance matrix.

As suggested above, the base unit uses a fed-back spatial covariance matrix or matrices to compute transmit weights and for other purposes as will become more fully apparent from the discussion herein. In one embodiment, the remote unit computes the spatial covariance matrix based on a measured downlink matrix channel response. The computation of spatial covariance matrices is known generally by those having ordinary skill in the art. The present disclosure is not intended to be limited to any particular method or technique of computing a spatial covariance matrix. In some implementations, the base unit indicates which portion of the operational bandwidth for which the one or more spatial covariance matrices should be computed by the remote unit. This indication could be explicit or implied.

In one implementation, the remote unit computes one or more spatial covariance matrices and transmits a representation thereof to the base unit using multiple time intervals. In one embodiment, the base unit uses the spatial covariance matrix or matrices received from the remote unit to compute beamforming weights (i.e., complex-valued weighting factors for each transmit antenna). In one embodiment, a base unit may use the covariance matrix accumulated over the entire band (or dominant eigenvector(s) computed from the covariance matrix accumulated over the entire band) for computing the beamforming weights that will then be the same on all subcarriers. In another embodiment, a base unit may use the covariance matrix specific to a portion of the band (or the dominant eigenvector(s) computed from the covariance matrix specific to a portion of the band) for beamforming only in the corresponding portion of the band. In one embodiment, the base unit may request periodic feedback of the covariance matrix corresponding to a portion of the band or its entirety or both. In another embodiment, the base unit commands the remote unit to compute and feedback the covariance matrix or matrices on an as-needed basis or on a periodic basis. The identity of the bands corresponding to a covariance matrix that is fed back may be indicated by the eNodeB, determined by the MS or configured by higher-layer signaling.

In another embodiment, the base unit uses a covariance matrix or matrices that is (are) fed back from the remote unit to compute multiple transmit weight vectors for use in multi-stream beamforming or closed-loop MIMO applications where multiple spatial channels are simultaneously formed (one formed by each transmit weight vector) so as to realize a spatial multiplexing gain on the time-frequency resources used for transmission to the mobile unit. The remote unit receiving transmission may or may not be served by the base-unit. A serving base unit for a particular remote unit is defined as one that transmits primary control information to the remote unit. When the remote unit is not served by the base-unit, the transmission may be referred to as a coordinated multi-point (CoMP) transmission.

In another embodiment, the base unit uses the covariance matrices fed back from multiple remote units to compute multiple transmit weight vectors for the purpose of realizing multi-user MIMO transmission (also called transmit Spatial Division Multiple Access (SDMA)) to multiple remote units simultaneously on the same time-frequency resources. One or more of the remote units receiving transmission may not be served by the base-unit. When the remote unit is not served by the base-unit, the transmission may be referred as a coordinated multi-point (CoMP) transmission.

In another implementation, the remote unit computes multiple spatial covariance matrices for the set of multiple covariance matrices that correspond to different portions of the operational band, and transmits the matrices to the base unit per the allocation by the base unit. In one embodiment, the base unit uses the spatial covariance matrices received from the remote unit to compute transmit weights for frequency selective scheduling (FSS) applications. The group of subcarriers (frequency band) that are used to derive spatial covariance matrices can be chosen by a remote unit or by a base unit. The time gap from one feedback of this information to the next feedback can be decided by a remote unit or by a base unit based on factors such as remote unit moving speed, SNR, etc.

In another implementation a BS may send or receive a covariance matrix (fed back by a MS) from another BS through an in-band or out-of-band backhaul link. A BS may determine transmit weights for one or more served MSs using multiple covariance matrices received in this fashion from other BSs.

A covariance matrix feedback is obtained by summing the per-subcarrier covariance matrix defined as Rᵢ above over all the subcarriers in the entire band or a subset of subcarriers associated with a sub-band (or allocation), whose index can be denoted as j in the mathematical expressions below. Such association of a spatial covariance matrix to the entire or sub-band may be explicitly or implicitly signaled by the base unit.

The spatial covariance matrix accumulated over subcarriers that belong to the j^{th} sub-band can be written as

$$R = {\sum }_{i ∈ {B}_{j}}^{ } {H}_{i}^{H} {H}_{i}$$

where Bⱼ is the set of subcarriers associated with the band or allocation index. The matrix R is a N_{T}×N_{T} matrix which can be represented as below

$$R = [ \begin{matrix}{R}_{1 , 1} & {R}_{1 , 2} & … & {R}_{1 , {N}_{T}} \\ {R}_{2 , 1} & {R}_{2 , 2} & & {R}_{2 , {N}_{T}} \\ ⋮ & & ⋱ & \\ {R}_{{N}_{T} , 1} & {R}_{{N}_{T} , 2} & & {R}_{{N}_{T} , {N}_{T}}\end{matrix} ]$$

with N_{T}² entries where N_{T} denotes the number of transmit antennas.

The covariance matrix may be normalized and quantized before feedback as

R_{q}=Q(R/trace(R))

where trace(A) means the sum of the diagonal elements of the matrix A and Q( ) is the quantization function and some example quantization methods are described below. The normalization need not be done with the same covariance matrix which is being fed back. For example in CoMP operation it may be preferable to have a relative power weighting between two or more different covariance matrices to assist in designing transmit weights. For this case the normalization may be done via

R_{q}=Q(R/trace(R_{d}))

where R_{d} is the covariance matrix used to normalize all covariance matrices (i.e., R_{d} is the covariance matrix of the desired or serving cell/BS).

In the preferred embodiment, a rank-2 approximate of the covariance matrix based on codebook vectors is used to quantize covariance matrix R. In this method, matrix R is approximated by

R_{q}=e₁v₁v₁^{H}+e₂v₂v₂^{H}

where e₁ and e₂ are constants, it is assumed that e₁>e₂, e₁ and e₂ or the ratio of e₂/e₁ will be quantized to b bits, and v₁ and v₂ are vectors selected from a codebook of vectors, V, of size M_{T}×B. The constants e1 and e2 may also be referred to as scalars, CBCM constants, CBCM scalars, weighting values, or CBCM weighting values. The steps for this method are:
1. Compute the covariance matrix R from downlink pilot data send from all transmit antennas at the BS.
2. Normalize R by the trace of R, i.e., set R=R/trace(R).
3. Find the dominant eigenvector (u₁) of R, and its eigenvalue q₁.
4. Determine e₁ as the quantization of q₁ to b bits (one option for quantizing e₁ is to quantize it to 2^{b} values between 0.5 and 1.0).
5. Choose v₁ as the vector from V that is closest to u₁.
6. Compute \tilde{R}=R−e₁v₁v₁^{H}.
7. Find the dominant eigenvector (u₂) of \tilde{R} and its eigenvalue q₂.
8. Determine e₂ as the quantization of q₂ to b bits (one option for quantizing e₂ is to quantize it to 2^{b} values between 0 and 0.5).
9. Choose v₂ as the vector from V that is closest to u₂.
10. Feedback the codebook indices of v₁ and v₂ along with e₁ and e₂.

In steps 3 and 7 for determining the closest vector v from V to u the following metric may be used:

v=arg max(|v^{H}u|)

Note that in the above method that both constants e₁ and e₂ are fed back. In an alternate embodiment only the ratio of the two constants is fed back to lower the feedback overhead and it is assumed that e₁+e₂=1. In another embodiment the quantization is done as follows:

R_{q}=e₁v₁v₁^{H}+(1−e₁)v₂v₂^{H}
1. Compute the covariance matrix R from downlink pilot data send from all transmit antennas at the BS.
2. Normalize R by the trace of R, i.e., set R=R/trace(R). (Alternatively R can be normalized by the two dominant eigenvalues, q₁+q₂.)
3. Find the dominant eigenvector (u₁) of R, and its eigenvalue Q.
4. Determine e₁ as the quantization of q₁ to b bits (one option for quantizing e₁ is to quantize it to 2^{b} values between 0.5 and 1.0).
5. Choose v₁ as the vector from V that is closest to u₁.
6. Compute \tilde{R}=R−e₁v₁v₁^{H}.
7. Find the dominant eigenvector (u₂) of \tilde{R}.
8. Choose v₂ as the vector from V that is closest to u₂.
9. Feedback the codebook indices of v₁ and v₂ along with e₁.

Note that the above algorithm only feeds back e₁, an alternative form is to feedback only e₂ using the following quantization:

R_{q}=(1−e₂)v₁v₁^{H}+e₂v₂v₂^{H}

Another embodiment of the invention is the following:

An algorithm of quantizing R with codebook based PMI is described below. The cost function is given by

$${e}_{1}^{*} , {e}_{2}^{*} , {v}_{1}^{*} , {v}_{2}^{*} = {arg min}_{{e}_{1} , {e}_{1} , {v}_{1} , {v}_{2}} {‖ R - ( {e}_{1} {v}_{1} {v}_{1}^{H} + {e}_{2} {v}_{2} {v}_{2}^{H} ) ‖}_{F}^{2} \qquad ( 1 )$$

The algorithm is iterative and is given as follows:

Initialize the algorithm with

### Step 0: R^{(k)}=R

(for k-th iteration):
Step 1: v₁^{(k)}=arg max v₁^{H} R^{(k)}v₁, e₁^{(k)}=Q(v₁^{(k)H} R^{(k)}v₁^{(k)}) where Q(x) in this case means to quantize x to b bits.
Step 2: R^{(k)}=R−e₁^{(k)}v₁^{(k)}v₁^{(k)H}
Step 3: v₂^{(k)}=arg max v₂^{H} R^{(k)}v₂, e₂^{(k)}=Q(v₂^{(k)H} R^{(k)}v₂^{(k)}) where Q(x) in this case means to quantize x to b bits.
Step 4: R^{(k+1)}=R−α₂^{(k)} v₂^{(k)} v₂^{(k)H}

After the initialization step, steps 1-4 are repeated until a performance measure (based on equation (1)) is satisfied. The matrix R could be trace normalized to limit values of e₁*, e₂* between [0,1]. The algorithm naturally extends to higher rank approximations.

Similar to the above algorithm, this iterative method can be extended to the following approximation:

R_{q}=e₁v₁v₁^{H}+(1−e₁)v₂v₂^{H}

The above algorithms give an elegant means of feeding back the covariance matrix. For CoMP operation it may be desirable to provide relative powers between the covariance matrix of the desired BS and the covariance matrix of the other cells/BSs. One option is for the covariance matrices for all BSs/cells to be quantized as above (with the same normalization) and then an additional feedback value which is a quantized power ratio between the desired BS's covariance matrix and the other BS/cell's covariance matrix will be fed back by the remote unit. Another option, as mentioned above, is to normalize all covariance matrices by the trace of the covariance matrix for the desired BS/cell. In this option the range of quantization of e₁ and e₂ may need to change for the other BSs/Cells than the desired one.

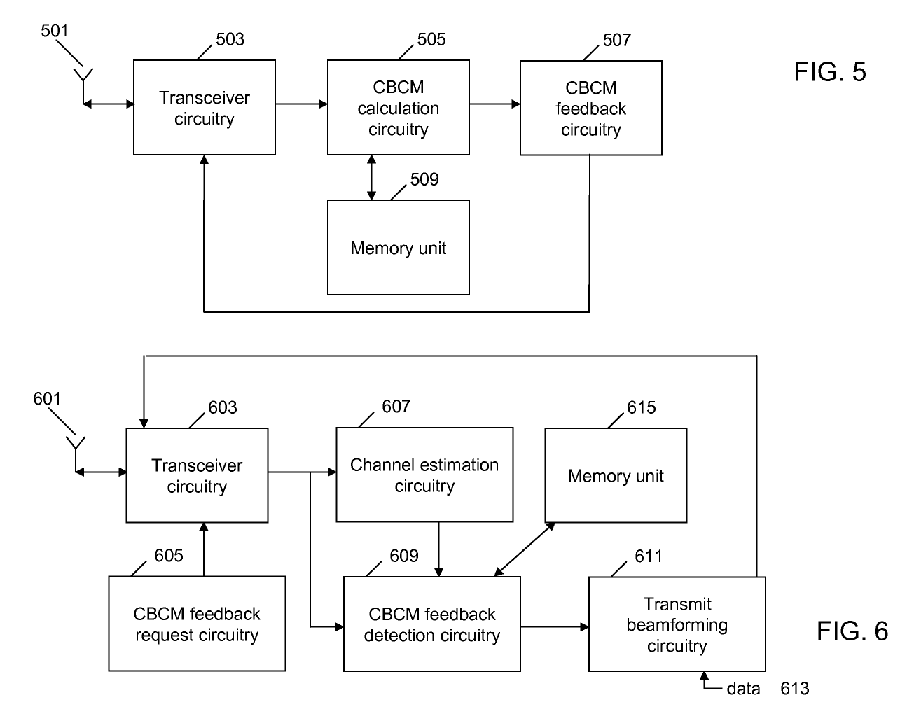

FIG. 5 is a block diagram of a remote unit using an uplink feedback channel. Transceiver circuitry 503 receives a CBCM feedback request signal from a base unit on an antenna or an array of antennas 501 along with downlink pilot symbols. The downlink pilot symbols may or may not be transmitted from the serving base station. In response to the CBCM feedback request, the mobile unit calculates a covariance matrix (R) at time t as a function of the received downlink pilot symbols in the CBCM calculation circuitry 505. This covariance matrix may be averaged together, with a previous estimate obtained from the memory unit 509. The CBCM calculation circuitry 505 then normalizes and quantizes R via any technique described above. Preferably this is accomplished by determining v₁, v₂, e₁, and e₂ from R, and using feedback circuitry 507 to feed back the codebook indices of v₁ and v₂ along with the bit values representing e₁ and e₂ by using transceiver 503 to transmit R_{q} wirelessly.

As shown in FIG. 5, CBCM feedback circuitry 507 is provided to create the specific CBCM feedback waveforms from the CBCM feedback generated by the CBCM feedback calculation circuitry 505. Once the CBCM feedback waveform is created by the CBCM feedback circuitry 507, then the CBCM feedback waveform is sent to the base unit via the transceiver circuitry 503. The operation of sending the CBCM feedback may be repeated two or more times to provide additional CBCM feedback.

FIG. 6 is a block diagram of a base unit employing CBCM feedback. The base unit first determines that a mobile unit should send CBCM feedback along with what frequencies the feedback should be for. This information is sent in a CBCM feedback request signal generated by CBCM feedback request circuitry 605. The CBCM feedback request signal is provided to the transceiver circuitry 603 which sends the signal to the remote unit over an antenna or an array of antennas 601.

In addition to the CBCM feedback request signal, pilot symbols might also be sent out of each of the transmit antennas by the transceiver circuitry 603. In response to the CBCM feedback request sent to the remote unit, transceiver circuitry 603 will receive a CBCM feedback signal (consisting of the quantized covariance matrix, R_{q}, which is preferably quantized through the codebook indices of v₁ and v₂ and the bit values representing e₁ and e₂, although may be quantized in any technique described above) from the mobile unit. The transceiver circuitry 603 will send the received CBCM feedback signal to the CBCM feedback detection circuitry 609 and may optionally send the received CBCM feedback signal to channel estimation circuitry 607 if coherent detection is used on the feedback channel. Channel estimation circuitry 607 will use the pilot symbols optionally contained in the CBCM feedback signal to obtain channel estimates. If coherent demodulation is used, these channel estimates are provided to the CBCM feedback detection circuitry 609 to equalize the data portion of the CBCM feedback signal which contains the codebook indices of v₁ and v₂ and the bit values representing e₁ and e₂ and ultimately compute a covariance matrix estimate from these detected indices and bit values.

If non-coherent demodulation is used, the CBCM feedback detection circuitry 609 estimates the codebook indices of v₁ and v₂ and the bit values representing e₁ and e₂ directly from the CBCM feedback signal. The covariance matrix is then derived directly from these detected indices and bit values.

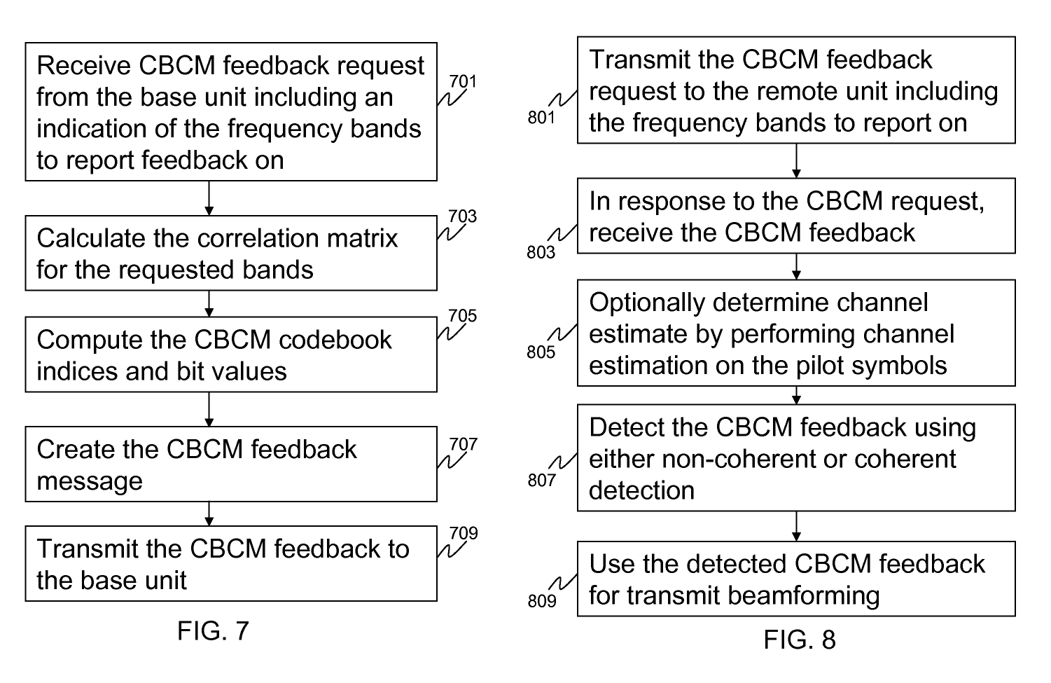

FIG. 7 is a flow chart showing operation of the mobile unit creating a CBCM feedback waveform (signal or message). The logic flow begins at step 701 where transceiver circuitry 503 receives a request to supply a feedback of channel information. As discussed above, the request is received from a base station and may also contain the frequency bands to report feedback on. At step 703 CBCM feedback calculation circuitry 505 calculates a covariance matrix at time t (R) as a function of a received downlink signal; and then in step 705 calculates the codebook indices of v₁ and v₂ and the bit values representing e₁ and e₂ as described above. (Note that any technique described above may be used to calculate a normalized and quantized value for R). The CBCM values (the codebook indices and the bit values) are then used to create a CBCM feedback message (signal or waveform) by CBCM feedback circuitry 507 and may be transmitted with pilots on a proper feedback channel to a base unit (step 709).

FIG. 8 is a flow chart showing operation of requesting and receiving CBCM feedback at a base unit when the base unit determines that channel information is needed regarding a channel existing between the base unit and a mobile station. The logic flow begins at step 801 where transceiver 603 transmits a CBCM feedback request to a remote unit where the CBCM feedback request includes a frequency band to report on. At step 803, and in response to the request, transceiver 603 receives the feedback (the codebook indices relating to a normalized and quantized value of R, preferably indices relating to v₁ and v₂ and the bit values representing e₁ and e₂) as a CBCM waveform on a proper feedback channel. Optionally (if coherent detection of the CBCM waveform is used) channel estimation circuitry 607 determines channel estimates from the pilots optionally contained in the feedback channel (step 805). Additionally, CBCM feedback detection circuitry 609 uses non-coherent or coherent detection to detect the CBCM values send by the remote unit and uses the CBCM values to compute a covariance matrix estimate to use for beamforming (step 807). Finally at step 809, CBCM feedback detection circuitry 609 uses the covariance matrix estimate to determine appropriate channel beamforming weights, and instructs transmit beamforming circuitry 611 to use the appropriate weights.

In a preferred embodiment of the present invention, base units and remote units utilizes a network protocol as described by the IEEE 802.16m or 3gpp long term evolution (LTE) standard specification. The following text provides changes to the IEEE 802.16m or 3gpp long term evolution (LTE) standard that facilitate the above-described messaging.

We also observe that there are certain benefits in feeding back covariance matrix information to the eNodeB. Specifically
A covariance matrix estimate provides multi-rank precoder information to the eNodeB. This provides the flexibility to the eNodeB to decide the rank, MCS and MU/SU transmission for an UE. This also maximizes the benefit of UE-specific RS where the eNodeB has the freedom to choose transmit weights. In contrast a Rel-8 like PMI strategy assigns the responsibility of deciding the rank, MCS to an UE which is a good strategy for CRS-based designs optimized for SU-MIMO transmissions. In simulations we observe that a significant fraction of UEs assigned rank-2 transmission in a SU system simulation is assigned a rank-1 (MU) transmission in a SU+MU system simulation. Therefore the optimal rank from an UE perspective could be rank-2 but from an eNodeB/system perspective it could very well be rank-1.
A covariance based feedback strategy could work with only TxD CQI feedback from an UE (similar to an agreement in Rel-9). Therefore CSI-RS needs to be designed to enable accurate covariance matrix estimation (and not per-subcarrier channel estimation). This will potentially require a smaller density of CSI-RS particularly in the case of CoMP where the overhead of CSI-RS from multiple cells and multiple antennas could be overwhelming.
The codebooks designed for PMI feedback are optimized for channel conditions supported by several channel models and in particular for uniform linear array (ULA) performance when the transmit array is DOD calibrated. In reality a random phase component is present in each RF chain at the eNodeB when it is not calibrated (see Error! Reference source not found. for details) and could degrade the performance of PMI-based MU-MIMO schemes significantly.
   The covariance matrix for feedback is computed on the downlink by the UE by adding the contribution of the channel estimated from each receive antenna to each transmit antenna the eNodeB.

$${M}_{T} \times {M}_{T} r = {\sum }_{k = 1}^{K} {H ( k )}^{H} H ( k ) , \qquad ( 1 )$$

where M_{T} is the number of transmit antennas, K is the number of subcarriers that the matrix is averaged over (which are not necessarily consecutive), H(k) is the M_{T}×M_{R} channel estimate on subcarrier k found on the downlink broadcast pilots, and M_{R} is the number of receive antennas.
Quantization with Codebook Feedback and a Rank-2 Update
In this method the covariance matrix is quantized according to

R_{q}=e₁v₁v₁^{H}+e₂v₂v₂^{H}, (2)

where v₁ and v₂ are chosen from a codebook (e.g., the R8 codebook) and e1 and e2 are scalars with e1>e2. All values may be chosen from the following equation

$${e}_{1}^{*} , {e}_{2}^{*} , {v}_{1}^{*} , {v}_{2}^{*} = {arg min}_{{e}_{1} , {e}_{1} , {v}_{1} , {v}_{2}} {‖ R - ( {e}_{1} {v}_{1} {v}_{1}^{H} + {e}_{2} {v}_{2} {v}_{2}^{H} ) ‖}_{F}^{2} . \qquad ( 3 )$$

The UE would feedback e₁ and e₂ quantized to b bits (where b is TBD) and the vectors v₁ and v₂ chosen from the R8 codebook for four transmit antennas and from a TBD codebook for eight transmit antennas.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method for closed-loop transmission feedback in wireless communication system, the method comprising the steps of:
receiving by a wireless node, a request for a codebook-based covariance matrix (CBCM) feedback;
calculating by the wireless node, a covariance matrix (R) as a function of a received downlink signal;
quantizing, by the wireless node, the covariance matrix (R) into indices using at least a rank two approximation of the covariance matrix; and
transmitting the indices for the quantized covariance matrix.

2. The method of claim 1 wherein the step of quantizing the covariance matrix into indices using at least a rank two approximation of the covariance matrix includes the step of quantizing the covariance matrix as a function of at least two vectors selected from a codebook of vectors and where the indices are codebook indices.

3. The method of claim 2 wherein the step of quantizing the covariance matrix includes the step of at least one b bit scalar quantization.

4. The method of claim 1 wherein the step of quantizing the covariance matrix includes the step of normalizing the covariance matrix (R).

5. The method of claim 4 wherein the step of normalizing R is accomplished by setting R=R/trace(R).

6. The method of claim 1 wherein the received downlink signal comprises pilot symbols.

7. The method of claim 1 wherein the step of quantizing R comprises the steps of:
finding the dominant eigenvector (u₁) of R, and its eigenvalue q₁;
determining e₁ as the quantization of q₁ to b bits;
choosing v₁ as the vector from V that is closest to u₁;
computing \tilde{R}=R−e₁v₁v₁^{H};
finding a dominant eigenvector (u₂) of \tilde{R} and its eigenvalue q₂;
determining e₂ as the quantization of q₂ to b bits;
choosing v₂ as the vector from V that is closest to u₂; and
transmitting codebook indices of v₁ and v₂ along with e₁ and e₂.

8. The method of claim 1 wherein the step of transmitting the indices causes a base station to use appropriate channel beamforming weights.

9. An apparatus comprising:
a receiver receiving a request for a codebook-based covariance matrix (CBCM) feedback;
circuitry calculating a covariance matrix (R) as a function of a received downlink signal, and quantizing the covariance matrix (R) into indices using at least a rank two approximation of the covariance matrix; and
a transmitter transmitting the indices for the quantized covariance matrix.

10. The apparatus of claim 9 wherein quantizing the covariance matrix includes the step of normalizing the covariance matrix (R).

11. The apparatus of claim 9 wherein quantizing the covariance matrix into indices using at least a rank two approximation of the covariance matrix includes the step of quantizing the covariance matrix as a function of at least two vectors selected from a codebook of vectors and where the indices are codebook indices.

12. The apparatus of claim 9 wherein quantizing the covariance matrix includes the step of at least one b bit scalar quantization.

13. The apparatus of claim 9 wherein the received downlink signal comprises pilot symbols.

14. The apparatus of claim 10 wherein normalizing R is accomplished by setting R=R/trace(R).

15. The apparatus of claim 9 wherein quantizing R comprises:
finding the dominant eigenvector (u₁) of R, and its eigenvalue q₁;
determining e₁ as the quantization of q₁ to b bits;
choosing v₁ as the vector from V that is closest to u₁;
computing \tilde{R}=R−e₁v₁v₁^{H};
finding a dominant eigenvector (u₂) of \tilde{R} and its eigenvalue q₂;
determining e₂ as the quantization of q₂ to b bits;
choosing v₂ as the vector from V that is closest to u₂; and
transmitting codebook indices of v₁ and v₂ along with e₁ and e₂.

16. The apparatus of claim 9 wherein transmitting the indices for the quantized covariance matrix causes a base station to use appropriate channel beamforming weights.
